(19) United States
(12) Patent Application Publication
(10) Pub. No.: US 2022/0073080 A1
(43) Pub. Date: Mar. 10, 2022

(54) AUTONOMOUS TRAVELING CART

(71) Applicant: TOYOTA JIDOSHA KABUSHIKI KAISHA, Toyota-shi Aichi-ken (JP)

(72) Inventors: Daisuke Sato, Susono-shi (JP); Daisuke Ishii, Sunto-gun (JP); Hiroki Izu, Nagoya-shi (JP); Hiroki Morita, Hiratsuka-shi (JP); Kei Sato, Toyota-shi (JP); Masaki Nanahara, Toyota-shi (JP); Kazumi Serizawa, Toyota-shi (JP); Hironobu Tanaka, Shinagawa-ku (JP); Shunsuke Mogi, Hachioji-shi (JP); Takashi Hayashi, Nagoya-shi (JP); Akihiro Kusumoto, Susono-shi (JP)

(21) Appl. No.: 17/469,393

(22) Filed: Sep. 8, 2021

(30) Foreign Application Priority Data
Sep. 10, 2020 (JP) 2020-152134

(51) Int. Cl. B60W 40/08

(52) U.S. Cl. CPC B60W 40/08; B60W 2040/0881; B60W 2420/42

(57) ABSTRACT

The autonomous traveling cart according to the present disclosure, which includes a person, an object, or both as a transport target, comprises a deck on which the transport target is placed and a sensing device configured to detect a disappearance of the transport target from the deck. At least a part of a periphery of the deck is opened for better accessibility to the deck for the transport target. The autonomous traveling cart according to the present disclosure also comprises a controller configured to stop traveling control for transporting the transport target in response to detection of the disappearance of the transport target by the sensing device.

### CROSS-REFERENCE TO RELATED APPLICATION

The present application claims priority under 35 U.S.C. § 119 to Japanese Patent Application No. 2020-152134, filed Sep. 10, 2020, the contents of which are incorporated herein by reference in their entirety.

### BACKGROUND

### Field

The present disclosure relates to an autonomous traveling cart including a person, an object, or both as a transport target.

### Background Art

JP 2016-107817A discloses a prior art relating to a system for preventing vehicle interior accidents. The system judges the danger in an observation area set based on contents photographed by an omnidirectional camera installed in a vehicle cabin, and notifies an alert according to the judgement result. Thus, various proposals have been made on safety measures against vehicle interior accidents for a long time.

### SUMMARY

Incidentally, the applicant for the present application is developing an autonomous traveling cart utilizing an autonomous traveling technique. The autonomous traveling cart includes a person, an object, or both as a transport target, and all operations to a destination are performed automatically. To enhance the convenience of the autonomous traveling cart, it is important to ensure accessibility to a deck on which a transport target is placed. That is, if the transport target is a person, it is desired that the person can easily get on the deck and can easily get off the deck. Also, if the transport target is an object, it is desirable that the object can be easily put on the deck and can be easily unloaded from the deck. However, improving the accessibility may cause guards for the transport target to become loose.

In view of the above problems, it is an object of the present disclosure to provide an autonomous traveling cart which has good accessibility to a deck for a transport target, and which is provided with a countermeasure against a negative aspect caused by improving the accessibility.

To achieve the above object, an autonomous traveling cart according to the present disclosure, which includes a person, an object, or both as a transport target, comprises a deck on which the transport target is placed and a sensing device configured to detect a disappearance of the transport target from the deck. At least a part of a periphery of the deck is opened for better accessibility to the deck for the transport target. The autonomous traveling cart according to the present disclosure also comprises a controller configured to stop traveling control for transporting the transport target in response to detection of the disappearance of the transport target by the sensing device.

According to the above configuration, the accessibility to the deck for the transport target is improved by the deck at least of a part of the periphery of which is opened. In addition, since at least a part of the periphery of the deck is opened, there is a possibility that the transport target may disappear during traveling, but the traveling control for transporting the transport target is stopped when the disappearance of the transport target is detected. In other words, the autonomous traveling cart according to the present disclosure has an enough countermeasure against the negative aspect caused by improving the accessibility.

The sensing device to detect the disappearance of the transport target may include a load sensor configured to measure a load on the deck. The sensing device may then detect the disappearance of the transport target based on a change in load or a change in load per unit time.

The sensing device to detect the disappearance of the transport target may include a camera configured to monitor the deck. The sensing device may then detect the disappearance of the transport target based on a monitoring image of the transport target obtained by the camera.

The sensing device to detect the disappearance of the transport target may include a load sensor configured to measure a load on the deck and a camera configured to monitor the deck. The sensing device may then detect the disappearance of the transport target based on a change in load or a change in load per unit time and a monitoring image of the transport target obtained by the camera.

The autonomous traveling cart according to the present disclosure may further comprise an alerting device. The alerting device is configured to alert another vehicle located in a vicinity of a route on which the autonomous traveling cart has traveled, in response to the detection of the disappearance of the transport target. According to this, it is possible to avoid a situation in which another vehicle comes into contact with the transport target which has disappeared from the autonomous traveling cart.

As described above, the autonomous traveling cart according to the present disclosure is advantageous in good accessibility to the deck for the transport target and advantageous as the countermeasure taken against the negative aspect caused by improving the accessibility.

### BRIEF DESCRIPTION OF THE DRAWINGS

FIG. 1 shows a schematic configuration of an autonomous traveling cart according to a first embodiment of the present disclosure.

FIG. 2 shows a schematic configuration of a body and a chassis of the autonomous traveling cart according to the first embodiment of the present disclosure.

FIG. 3 shows a configuration of a control system of the autonomous traveling cart according to the first embodiment of the present disclosure.

FIG. 4 shows a graph showing changes in load when someone gets on the deck and when someone gets off the deck.

FIG. 5 shows a graph showing changes in the amount of change in load per unit time when someone gets on the deck and when someone gets off the deck.

FIG. 6 shows a flowchart illustrating a control flow of the traveling control of the autonomous traveling cart according to the first embodiment of the present disclosure.

FIG. 7 shows a diagram illustrating inter-vehicle cooperation of the autonomous traveling cart according to the first embodiment of the present disclosure.

FIG. 8 shows a schematic configuration of the autonomous traveling cart according to a second embodiment of the present disclosure.

FIG. 9 shows a diagram illustrating a method of detecting a disappearance of a transport target by the autonomous traveling cart according to the second embodiment of the present disclosure.

### DETAILED DESCRIPTION

Hereunder, embodiments of the present disclosure will be described with reference to the drawings. Note that when the numerals of numbers, quantities, amounts, ranges and the like of respective elements are mentioned in the embodiments shown as follows, the present disclosure is not limited to the mentioned numerals unless explicitly described otherwise, or unless the disclosure is explicitly designated by the numerals theoretically. Furthermore, structures and steps that are described in the embodiments shown as follows are not always indispensable to the disclosure unless explicitly shown otherwise, or unless the disclosure is explicitly designated by the structures or the steps theoretically.

### 1. First Embodiment

### 1-1. Schematic Configuration of Autonomous Traveling Pallet

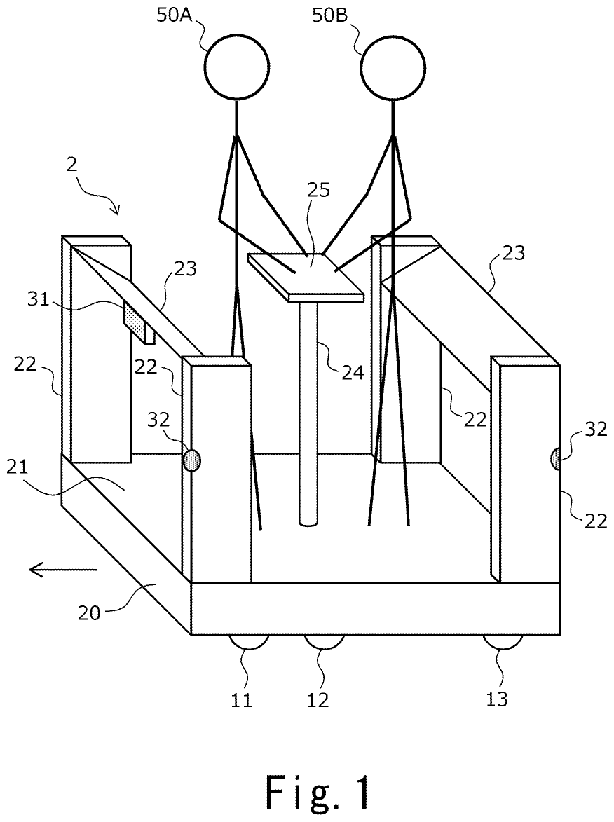

FIG. 1 shows a schematic configuration of an autonomous traveling cart according to the first embodiment of the present disclosure. The autonomous traveling cart 2 according to the present embodiment is an autonomous traveling cart having a pallet-type body 20. Therefore, in the following description, the autonomous traveling cart 2 according to the present embodiment is referred to as an autonomous traveling pallet. The autonomous traveling pallet 2 includes a person, an object, or both as a transport target.

The autonomous traveling pallet 2 is a low-floor cart of which the body 20 has a deck 21 whose height is about 30 cm from the ground. The body 20 is equipped with front wheels 11, middle wheels 12, and rear wheels 13 on the left and right sides thereunder. These wheels 11, 12, 13 can travel the autonomous traveling pallet 2 in either the leftward or rightward direction in FIG. 1. Here, the leftward direction as indicated by the arrow in FIG. 1 is the basic traveling direction of the autonomous traveling pallet 2. Then, the traveling direction is defined as the forward direction of the autonomous traveling pallet 2 and the opposite direction is defined as the backward direction of the autonomous traveling pallet 2.

The deck 21 is equipped with a post 22 on each of left and right sides of front and rear sides. A beam 23 is bridged between the front left and right posts 22 and 22. Similarly, another beam 23 is bridged between the rear left and right posts 22 and 22. The beams 23 can be used as seats by occupants 50A, 50B on the deck 21. A small table 25 supported by a single foot 24 is provided at the center of the deck 21.

There is an open space between the front and rear posts 22 and 22. When the autonomous traveling pallet 2 is used for human transport service, the occupants 50A, 50B can get on the deck 21 freely from the open space and can also get off the deck 21 freely through the open space. When the autonomous traveling pallet 2 is used for logistics, an object can be freely placed on the deck 21 from the open space between the front and rear posts 22 and 22. Also, the object can be freely unloaded from the deck 21 through the open space between the front and rear posts 22 and 22. The deck 21 having the open space on left and right sides provides the autonomous traveling pallet 2 with excellent accessibility to the deck 21 for the transport target.

The autonomous traveling pallet 2 is equipped with external sensors for autonomous traveling. The first external sensor is a LIDAR (Laser Imaging Detection and Ranging) 31. The LIDAR 31 is provided on each of the front upper portion and the rear upper portion of the autonomous traveling pallet 2 so as to sense the front and rear of the autonomous traveling pallet 2. Only the front upper LIDAR 31 is visible in FIG. 1. The second external sensor is a camera 32. The camera 32 is provided in each post 22 so as to photograph the right front, left front, right rear, and left rear of the autonomous traveling pallet 2. Only the left front and left rear cameras 32 are visible in FIG. 1.

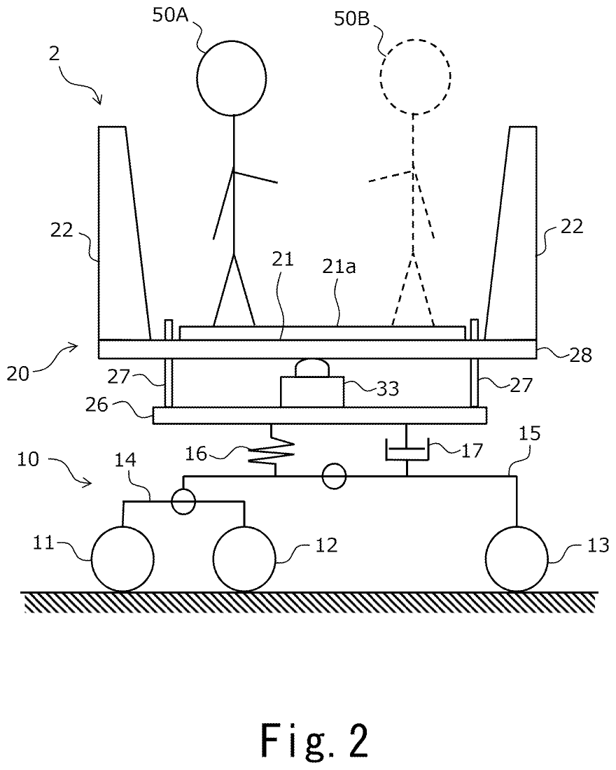

Next, a schematic configuration of the body 20 and the chassis 10 of the autonomous traveling pallet 2 will be described with reference to FIG. 2. The front wheels 11, middle wheels 12, and rear wheels 13 are mounted on the chassis 10. Each wheel 11, 12, 13 is driven by an independent motor (not shown) and can rotate at a speed and direction independent of each other. Specifically, the middle wheels 12 are normal wheels, but the front wheels 11 and the rear wheels 13 are omni wheels. Only the middle wheels 12, which are normal wheels, have the function of stopping the autonomous traveling pallet 2.

The chassis 10 consists of a bogie 14 and a rocker 15. The front wheels 11 and the middle wheels 12 are supported by the bogie 14. Specifically, motors for driving the front wheels 11, and motors for driving the middle wheels 12 are mounted on the bogie 14. The bogie 14 is swingably supported by the rocker 15. Motors for driving the rear wheels 13 are mounted on the rocker 15. Further, although not shown, a small battery having a high volume energy density, such as a lithium ion battery is mounted on the rocker 15.

The body 20 is mounted on the top of the rocker 15 via a spring 16 and a damper 17. The body 20 has a bottom plate 26 which rests on the spring 16 and the damper 17, and a floor plate 28 which rests on the top of the bottom plate 26 via a load sensor 33. Guides 27 extending in the vertical direction are fixed on the bottom plate 26. The floor plate 28 is restricted from moving in the horizontal direction with respect to the bottom plate 26 by the guides 27. The upper surface of the floor plate 28 is the deck 21, and the posts 22 stand on the floor plate 28. In addition, the deck 21 is covered with a mat 21a. The load sensor 33 is used to measure the amount of change in load applied to the deck 21 from the transport target transported by the autonomous traveling pallet 2.

### 1-2. Configuration of Control System of Autonomous Traveling Pallet

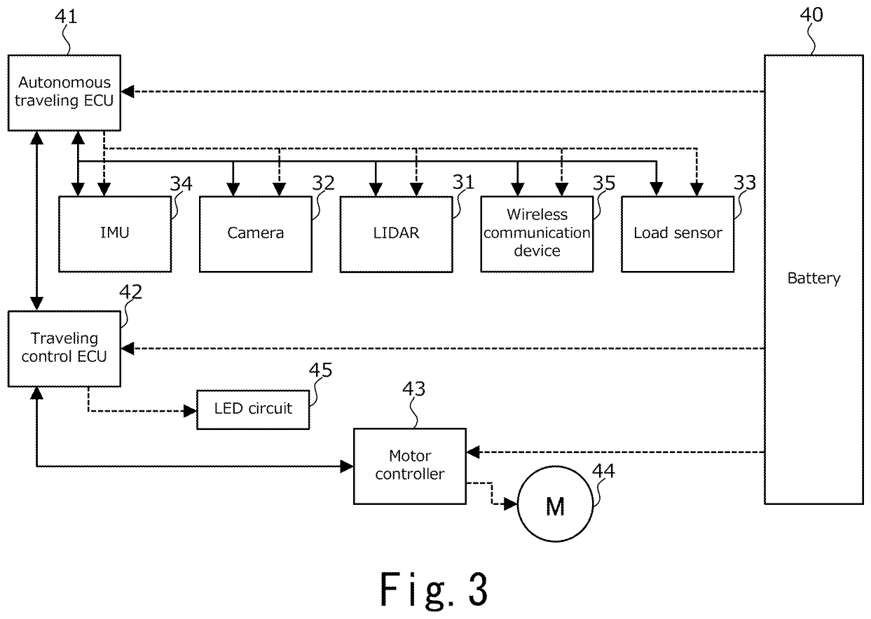

Next, a configuration of a control system of the autonomous traveling pallet 2 according to the present embodiment will be described with reference to FIG. 3. The autonomous traveling pallet 2 is equipped with two types of ECUs (Electronic Control Unit), i.e., an autonomous traveling ECU 41 and a traveling control ECU 42. Each ECU comprises a memory including at least one program and a processor coupled to the memory. A plurality of memories and processors may be provided.

The autonomous traveling ECU 41 is an ECU that controls autonomous traveling of the autonomous traveling pallet 2. The autonomous traveling ECU 41 has connections with the LIDAR 31, the camera 32, and the load sensor 33, and further connections with an IMU 34, and a wireless communication device 35. The LIDAR 31 is used for detection and ranging of an object existing around the autonomous traveling pallet 2. The camera 32 is used to recognize an object exiting around the autonomous traveling pallet 2. The IMU (Inertial Measurement Unit) 34 is used to measure angular velocity and acceleration of three axes. The wireless communication device 35 is used for vehicle-to-vehicle communication and road-to-vehicle communication utilizing 920 MHz band. The autonomous traveling ECU 41 is powered by a battery 40 mounted on the rocker 15. The autonomous traveling ECU 41 supplies power to the LIDAR 31, the camera 32, the load sensor 33, the IMU 34, and the wireless communication device 35.

Further, the autonomous traveling ECU 41 has a function of communicating with a control server (not shown) with mobile communication such as 4G or 5G. A user of the autonomous traveling pallet 2 communicates with the control server using a user terminal such as a smart phone or a tablet PC, and transmits a desired departure point and a desired destination to the control server. The control server selects an appropriate autonomous traveling pallet 2 from among a plurality of available autonomous traveling pallets 2 and transmits the departure point and the destination to the selected autonomous traveling pallet 2. The autonomous traveling ECU 41 prepares a travel plan based on the departure point and the destination received from the control server.

The autonomous traveling ECU 41 inputs a target trajectory calculated from the travel plan into the traveling control ECU 42. The traveling control ECU 42 generates a motor command value for causing the autonomous traveling pallet 2 to travel along the target trajectory. Since the front wheels 11 and the rear wheels 13 are omni wheels, the traveling direction can be controlled along the target trajectory by controlling the difference in rotational speed between the left and right motors. The motor command value generated by the traveling control ECU 42 is input to the motor controller 43. Further, the motor controller 43 is supplied power directly from the battery 40. The motor controller 43 controls the power supply to the motors 44 of the left and right wheels 11, 12, and 13 according to the motor command value.

Incidentally, the autonomous traveling pallet 2 is provided with a lighting device (not shown). An LED is used as the lighting device. An LED circuit 45 for lighting the LED is supplied power from the traveling control ECU 42. The traveling control ECU 42 is powered by the battery 40. The LED circuit 45 may light the LED at all times, or may light the LED depending on ambient illuminance.

### 1-3. Control of Autonomous Traveling Pallet

The operation of the autonomous traveling pallet 2 during autonomous traveling is controlled by the autonomous traveling ECU 41 as a controller. The autonomous traveling ECU 41 has a function of detecting a disappearance of the transport target based on the load data obtained from the load sensor 33. If the transport target is a person, the disappearance of the transport target means that an occupant gets off the autonomous traveling pallet 2 at a timing when he/she should not do so, for example, as when the autonomous traveling pallet 2 is traveling. The getting-off of the occupant in this case includes both intentional getting-off and unintentional accidental getting-off. If the transport target is an object, the disappearance of the transport target means, for example, that the object is dropped from the deck 21 or that the object is taken out at a timing when it should not be done so.

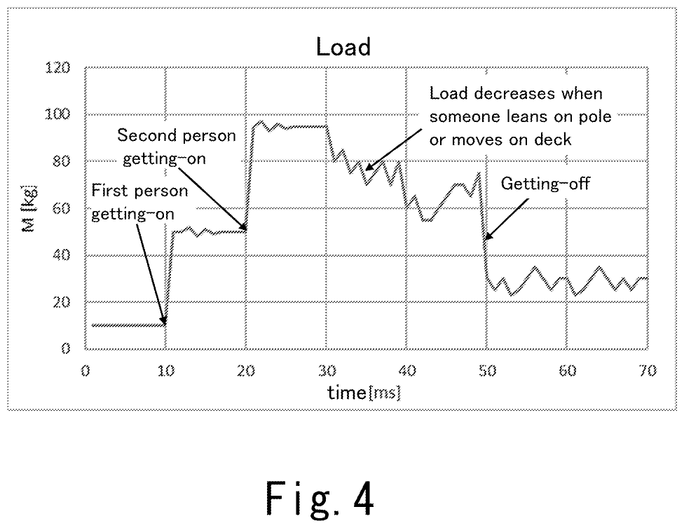

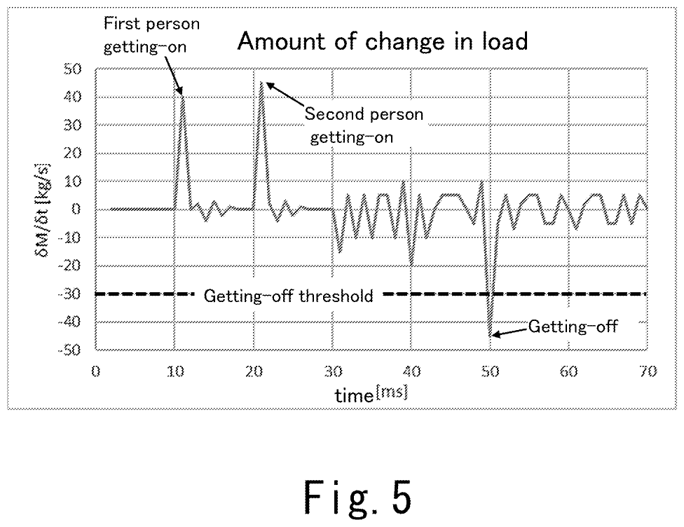

As a method of detecting the disappearance of the transport target based on the load data, there are a method based on a change in load data and a method based on the amount of change in load data. The amount of change in load data means the amount of change in load data per unit time. Both methods can be employed. Each method will be described below with reference to FIGS. 4 and 5.

FIG. 4 shows a graph showing an example of changes in load when someone gets on the deck 21 and when someone gets off the deck 21. As shown in this graph, the load M[kg] increases stepwise each time someone gets on the deck 21. By detecting this stepwise increase in load, it is possible to determine the time someone has gotten on the deck 21 and how many people have gotten on the deck 21. On the other hand, when someone gets off the deck 21, the load decreases stepwise regardless of whether the getting-off is intentional or unintentional. However, the load decreases when someone leans on the pole or moves on the deck 21. By providing a threshold for the amount of decrease in load, it is possible to determine whether someone has gotten off the deck 21 or simply has moved on the deck 21. However, since there are individual differences in body weight, there is a possibility that sufficient determination accuracy cannot be obtained by the method based on changes in load data.

FIG. 5 shows a graph showing an example of changes in the amount of change in load when someone gets on the deck 21 and when someone gets off the deck 21. As shown in this graph, the amount of change in load δM/δt [kg/s] increases pulse-wise each time someone gets on the deck 21. By detecting this pulse-wise increase in the amount of change in load, it is possible to determine the time someone has gotten on the deck 21 and how many people have gotten on the deck 21. On the other hand, when someone gets off the deck 21, the amount of change in load decreases pulse-wise regardless of whether the getting-off is intentional or unintentional. The change in load when someone gets off the deck 21 is abrupt, and is clearly large compared to the change in load that occurs when someone leans on the pole or moves on the deck 21. Therefore, by providing a threshold value for the amount of change in load in the decreasing direction, it can be determined that someone has got off the deck 21 when the amount of change in load decreases below the threshold value.

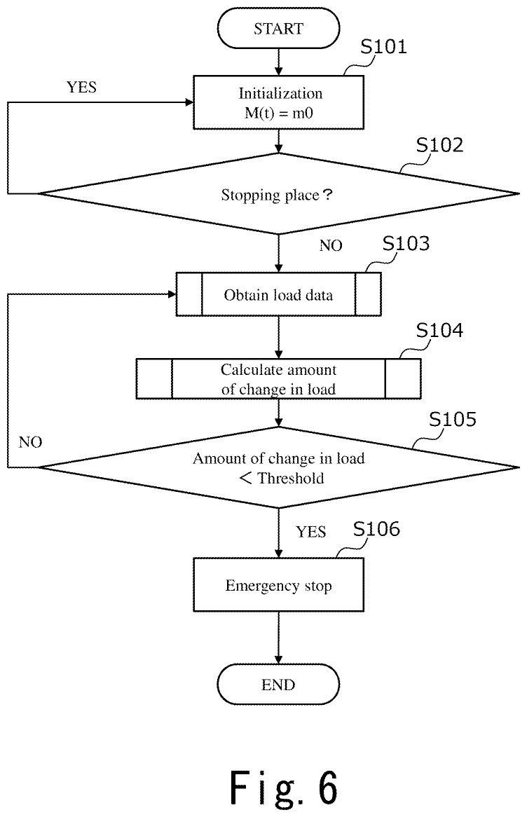

In the present embodiment, the autonomous traveling ECU 41 detects the disappearance of the transport target by the method based on the amount of change in load data, and controls the operation of the autonomous traveling pallet 2 based on the detection result. FIG. 6 is a flow chart illustrating a control flow of traveling control of the autonomous traveling pallet 2 executed by the autonomous traveling ECU 41.

The autonomous traveling ECU 41 automatically starts traveling control for transporting a person or an object, which is the transport target. At the start of the traveling control, the autonomous traveling ECU 41 executes the initialization of the data obtained from the load sensor 33. Specifically, the autonomous traveling ECU 41 resets the load data M (t) obtained from the load sensor 33 to an initial value m0 (step S101).

The autonomous traveling ECU 41 uses GPS-based location information and map information to determine whether the present location of the autonomous traveling pallet 2 is a stopping place determined in a traveling plan (step S102). While the autonomous traveling pallet 2 stops at the stopping place, the autonomous traveling ECU 41 maintains the load data M(t) at the initial value m0.

At the same time as the autonomous traveling pallet 2 starts moving from the stopping place, the autonomous traveling ECU 41 starts obtaining load data from the load sensor 33. The load data is obtained at regular intervals (step S103). The autonomous traveling ECU 41 calculates the load change amount, which is the amount of change in load per unit time, from the obtained load data (step S104).

The autonomous traveling ECU 41 determines whether the load change amount calculated in step S104 has decreased below the threshold value (step S105). While the load change amount is equal to or greater than the threshold, the autonomous traveling ECU 41 continues the traveling control for transporting a person or an object and repeats the processing of steps S103 to S104. Then, when the load change amount has decreased below the threshold, the autonomous traveling ECU 41 stops the traveling control for transporting a person or an object and makes the autonomous traveling pallet 2 stop emergently (step S106).

After an emergency stop of the autonomous traveling pallet 2, the autonomous traveling ECU 41, for example, photographs the surroundings of the autonomous traveling pallet 2 by the camera 32, and transmits the photographed image data to the control server. In a control center where the control server is installed, an operator checks the situation based on the image data sent from the autonomous traveling pallet 2 and takes a necessary measures according to the situation. The necessary measures include, for example, remotely controlling the autonomous traveling pallet 2, alerting, and communicating to the relevant places.

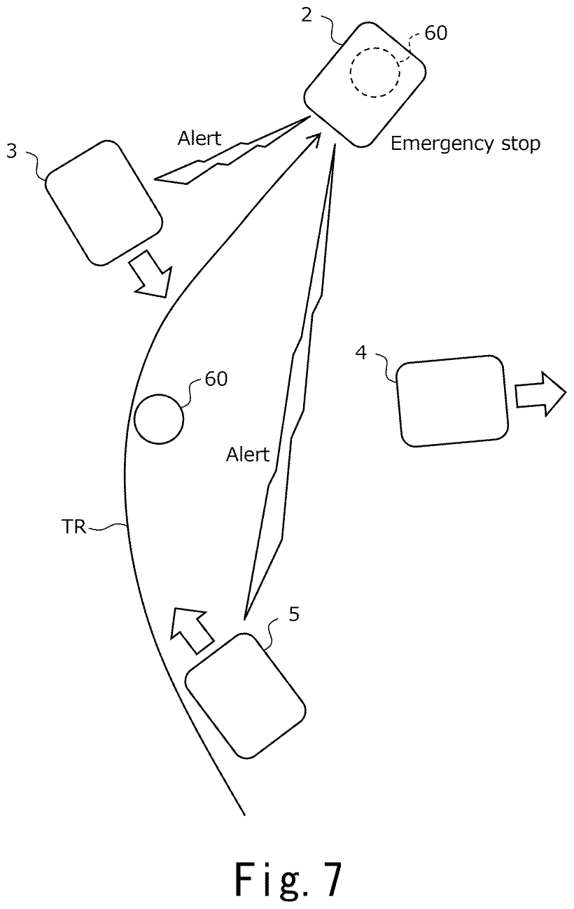

Further, after the emergency stop of the autonomous traveling pallet 2, the autonomous traveling ECU 41 executes inter-vehicle cooperation using vehicle-to-vehicle communication by the wireless communication device 35. FIG. 7 shows a diagram illustrating the inter-vehicle cooperation of the autonomous traveling pallet 2 by the autonomous traveling ECU 41. Since the autonomous traveling ECU 41 causes the autonomous traveling pallet 2 to travel along the target trajectory, it stores the route TR on which the autonomous traveling pallet 2 has traveled before the emergency stop. If the transport target 60 disappears from the deck 21 of the autonomous traveling pallet 2, the transport target 60 is likely to be on or around the route TR on which the autonomous traveling pallet 2 traveled. Therefore, the autonomous traveling ECU 41 executes vehicle-to-vehicle communication with other vehicles 3 and 5 located near the route TR on which the autonomous traveling pallet 2 has traveled to alert the vehicles 3 and 5. In this case, the autonomous traveling ECU 41 and the wireless communication device 35 functions as an alerting device for alerting the vehicles 3 and 5.

Specifically, the autonomous traveling ECU 41 sends alerts to the vehicle 5 that is currently traveling along the route TR of the autonomous traveling pallet 2 and the vehicle 3 that is approaching the route TR. No alert is sent to a vehicle 4 that is moving away from the route TR, even if it exists near the route TR. The vehicles 3 and 5 that have received the alerts make an emergency stop on the spot to avoid contact with the transport target 60 that may be around there. The vehicles 3 and 5 that have made an emergency stop may, for example, photograph the surroundings with a camera and transmit the photographed image data to the control server or the autonomous traveling pallet 2.

### 2. Second Embodiment

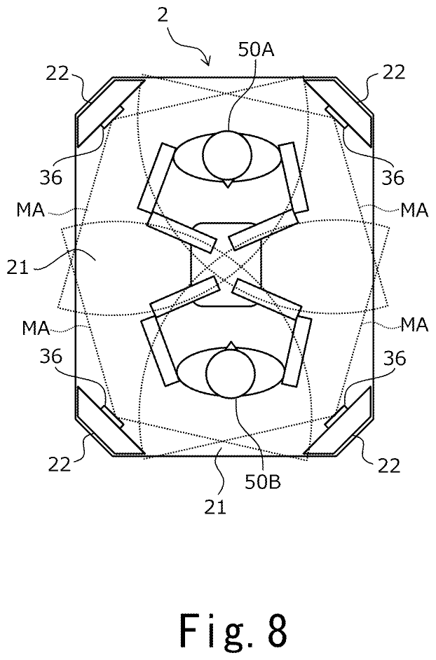

Next, the second embodiment of the present disclosure will be described. FIG. 8 shows a schematic configuration of the autonomous traveling cart according to the present embodiment. In FIG. 8, components and parts common to those of the first embodiment are denoted by the same reference numerals.

The present embodiment is different from the first embodiment in the configuration of the sensing device to detect a disappearance of the transport target from the deck 21. In the present embodiment, the autonomous traveling cart 2 is equipped with an inside camera 36 on each of the four posts 22. While the camera 32 (see FIG. 1) photographs the exterior, the inside camera 36 monitors the space above the deck 21 inside the autonomous traveling cart 2. Since the monitoring area MA by the four inside cameras 36 covers the space above the deck 21, occupants 50A, 50B on the deck 21 will be photographed by at least one of the four inside cameras 36.

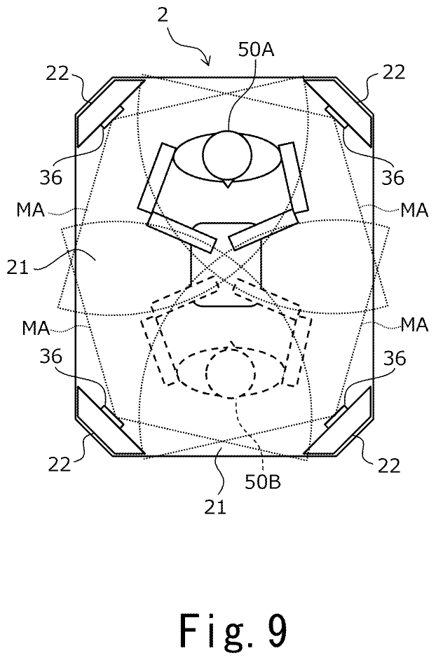

In the present embodiment, the inside camera 36 functions as the sensing device to detect the disappearance of the transport target from the deck 21. FIG. 9 is a diagram illustrating a method of detecting the disappearance of the transport target in the present embodiment. The autonomous traveling ECU (not shown) of the autonomous traveling cart 2 obtains monitoring images from the inside cameras 36 at regular intervals. For example, it is assumed that two occupants 50A and 50B are on the deck 21 at the start of travel. Then, when a single occupant 50B disappears from all the monitoring area MA of the inside cameras 36 at a certain timing, the autonomous traveling ECU determines that the occupant 50B has disappeared from the deck 21. In such a case, the autonomous traveling ECU stops the autonomous traveling cart 2 emergently.

In the present embodiment, whether or not the transport target is likely to go out of the deck 21 may be determined from the movement of the transport target on the deck 21 photographed by the inside cameras 36. The autonomous traveling ECU stops the autonomous traveling cart 2 emergently if the transport target is about to go out of the deck 21 while the autonomous traveling cart 2 is traveling. This makes it possible to prevent the disappearance from the deck 21 of the transport target in advance.

### 3. Other Embodiments

Finally, several other embodiments of the present disclosure will be described.

As the sensing device of detecting the disappearance of the transport target from the deck 21, both the load sensor 33 to measure the load on the deck 21 and the inside camera 36 to monitor the deck 21 may be installed. As described above, the change in load per unit time allows the disappearance of the transport target from the deck 21 to be detected more accurately than the change in load. However, for example, when the load suddenly decreases due to an occupant jumping up, there is a possibility of false detection depending on the setting of the threshold. On the other hand, when a large number of passengers are on board, detection using only the inside camera 36 may cause false detection because a small person or a seated person is hidden behind another person. Therefore, more accurate detection will be achieved by combining the detection result due to the change in load or the change in load per unit time with the detection result by the inside cameras 36.

The outer camera 32 may also be used as the sensing device to detect the disappearance of the transport target from the deck 21. For example, if a person who was not photographed by the right front camera 32 while the autonomous traveling cart 2 was traveling is photographed by the right rear camera 32, it is assumed that the person intentionally or unintentionally got off the deck 21. It is of course possible to combine the outer camera 32 with the load sensor 33 or combine the outer camera 32 with the inner camera 36.

The load sensor 33 can also be used for detecting capacity over or overloading of the autonomous traveling cart 2.

What is claimed is:

1. An autonomous traveling cart including a person, an object, or both as a transport target, comprising:
a deck on which the transport target is placed, wherein at least a part of a periphery of the deck is opened;
a sensing device configured to detect a disappearance of the transport target from the deck; and
a controller configured to stop traveling control for transporting the transport target in response to detection of the disappearance of the transport target.

2. The autonomous traveling cart according to claim 1,
wherein the sensing device includes a load sensor configured to measure a load on the deck, and detect the disappearance of the transport target based on a change in load or a change in load per unit time.

3. The autonomous traveling cart according to claim 1,
wherein the sensing device includes a camera configured to monitor the deck, and detect the disappearance of the transport target based on a monitoring image of the transport target obtained by the camera.

4. The autonomous traveling cart according to claim 1,
wherein the sensing device includes a load sensor configured to measure a load on the deck and a camera configured to monitor the deck, and detect the disappearance of the transport target based on a change in load or a change in load per unit time and a monitoring image of the transport target obtained by the camera.

5. The autonomous traveling cart according to claim 1, further comprising
an alerting device configured to alert another vehicle located in a vicinity of a route on which the autonomous traveling cart has traveled, in response to the detection of the disappearance of the transport target.
